(19) United States
(12) Patent Application Publication
(10) Pub. No.: US 2015/0251225 A1
(43) Pub. Date: Sep. 10, 2015

(54) WATER COLLECTION AND CLEANING

(71) Applicant: NEW YORK UNIVERSITY, New York, NY (US)

(72) Inventors: Ramesh Jagannathan, Abu Dhabi (AE); Mohammed Yaseer Omar, Abu Dhabi (AE); Mohammed Amine Belarbi, Abu Dhabi (AE); Coezette Sibanda, Abu Dhabi (AE); Ping-Yi Lu, Abu Dhabi (AE)

(73) Assignee: NEW YORK UNIVERSITY, New York, NY (US)

(21) Appl. No.: 14/642,485

(22) Filed: Mar. 9, 2015

Related U.S. Application Data
(60) Provisional application No. 61/950,633, filed on Mar. 10, 2014.

(51) Int. Cl. B08B 3/10; A47L 1/02

(52) U.S. Cl. CPC B08B 3/10; A47L 1/02

(57) ABSTRACT

Systems and methods for fluid harvesting and surface cleaning. A fluid harvesting device comprises a harvester having a hydrophobic surface and a collection device, adjacent the harvester, which receives fluid from the surface of the harvester.

### CROSS-REFERENCE TO RELATED APPLICATIONS

This application claims priority to U.S. Provisional Application No. 61/950,633, filed Mar. 10, 2014, reference of which is hereby incorporated in its entirety.

### BACKGROUND OF THE INVENTION

Water is becoming an increasingly precious commodity. As technology advances, the uses for water beyond simple nourishment are also increasing. Transporting water long distances is costly and inefficient. However, water is often required in locations that are water-poor, such as arid regions in the Middle East and Australia. The need for water in such regions to service the growing human population places a premium on water efficiency.

These same water-poor regions often also present an opportunity for efficient solar energy harvesting, in part due to the lack of water providing more sunny cloud-free days. However, to maintain efficiency it is important to maintain the optics of a solar collector as free from obstructions, such as sand, dirt, and debris, as possible. In addition, certain solar collectors or devices need to be cooled or optimally are cooled. For both cleaning and cooling, water is typically utilized. However, the procurement of water in sufficient quantities for traditional applications in a water-poor environment is difficult.

In addition, it is common to find skyscraper buildings in most modern cities around the world. Most, if not all skyscraper buildings are covered with a large surface area of glass, which needs to be cleaned on a regular basis. The most common method of cleaning them is to send a cleaning crew up and down a scaffold built around the glass surfaces and manually clean them. There has been some advancement in automating this process but these still remain expensive and cumbersome to use. It would be ideal if there was a cleaning mechanism available that is integrated into the glass panels and is part of the building architecture and which is able to automatically clean the glass surfaces on a regular basis.

### SUMMARY OF THE INVENTION

One implementation relates to a fluid harvesting device. The device includes a harvester comprising a hydrophobic surface. A collection device is adjacent to the harvester and configured to receive liquid from the surface of the harvester.

Another implementation relates to a cleaning device. A harvester is positioned on a collection device, the harvester having a surface for condensing water from air. The collection device includes an inlet in fluid communication with the surface of the harvester, the collection device further including an outlet. A wiper assembly comprising a first outer wiper blade and a second outer wiper blade with a fluid directing material is disposed there between. The fluid directing material is in fluid communication with the outlet of the collection device.

Another implementation relates to a method of collecting liquid and cleaning a surface. Liquid is condensed on a harvester's surface. The condensed liquid is channeled into a collection device. Liquid from the collection device is dispensed to a wiper assembly. A wiper of the wiper assembly is moved across a portion of the surface spreading water on the surface as the wiper is moved.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates one implementation of a Solar Panel

FIG. 2 illustrates one implementation of a Static Wiper System

FIG. 3 illustrates one implementation of a Wiper System in Motion

FIG. 4 illustrates one implementation of a Wiper System Moisture Sensors and Water Levels

FIG. 5 illustrates one implementation of a Wiper System for Skyscraper Buildings

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Described herein are systems and methods for collecting water and utilizing a liquid to clean a surface. One implementation relates to an automatic cleaning system that employs water collected from the ambient environment and an integrated wiper device. Power for the system may, optionally, be provided by a solar energy source. One non-limiting application of this implementation is to improve the efficiency of solar panels situated in areas with high dust collection by regularly, (preferably automatically) cleaning their surfaces. Another nonlimiting example of an application of this implementation is for cleaning surfaces, such as an exterior window or panel of a high-rise building where cleaning might be inconvenient, time consuming and expensive.

One implementation relies upon efficiently extracting and collecting the water from ambient humid air. The device consists of two main subsystems: a water harvester with a storage device, in one aspect cylindrical, and a wiper assembly, in one aspect solar powered, for using the collected water to clean the desired surface.

The water harvester system design utilizes hydrophobic and hydrophilic properties along with physical surface features to harvest water from air. The water collection device leverages available materials that provide a hydrophobic surface that is capable of efficiently condensing water from humid air. In one implementation, the water harvester is capable of harvesting up to 10 I/hr/m² off the surface.

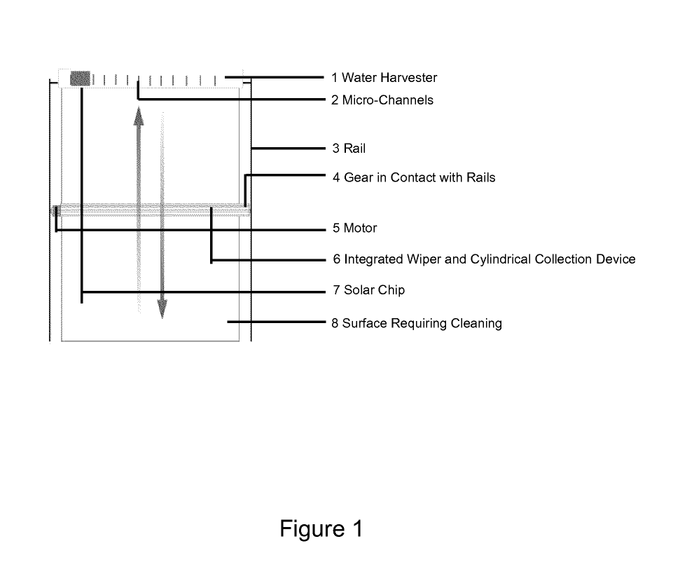

One implementation is shown in FIG. 1, the water harvester 1 is mounted on the top edge of the surface to be cleaned 8. A plurality of channels are present on the water harvester. In the illustrated implementation, the channels are micro-channels 2, whose width may range from 1 micrometer to 1000 micrometer and are perpendicular to the edge of the surface to be cleaned and run along the length of, the water harvester 1.

A collection device 6 is provided. The collection device 6 gathers water for use in cleaning the surface. As shown in FIG. 1, the micro channels 2 efficiently facilitate the flow of collected water droplets into a cylindrical collection device 6.

The collection device 6 may include an integrated wiper. In a further implementation, the collection device and wiper assembly may be separate components. The wiper 6 is moved by a wiping mechanism. As shown in the implementation of FIG. 1, one end of the collection device 6 is fitted with a gear in contact with the teeth on the rails 4. The other end is fitted with a motor 5 in contact with the rails through a system of a gear wheel or cog and teeth on the rails (rack rails) 3 to enable its locomotion to and from the bottom of the glass panel. Alternative implementations may use other motive force systems to impart linear motion to the wiper. In yet further implementations, the wiper may sweep across the surface in a curved motion similar to a windshield wiper.

In one implementation, the device and associate method of use include two phases: a water harvesting/collection phase and a cleaning phase. In one method of operation, once the water in the collection device 6 reaches a sufficient level, the integrated wiper/collector system 6 is set in motion and the cleaning phase is initiated. The cleaning action is stopped once the water level decreases below a set point and the wiper component returns to its initial position to resume water collection. In a further implementation, a time-out or other mechanism may also be used to end the cleaning phase, such as to conserve water.

The movement of the wiper blades employs a solar powered motor system 7. The solar power chip system is integrated into the wiper system 7. A power storage system such as a battery or capacitor can be utilized to provide for power to execute the cleaning phase in the absence of solar power.

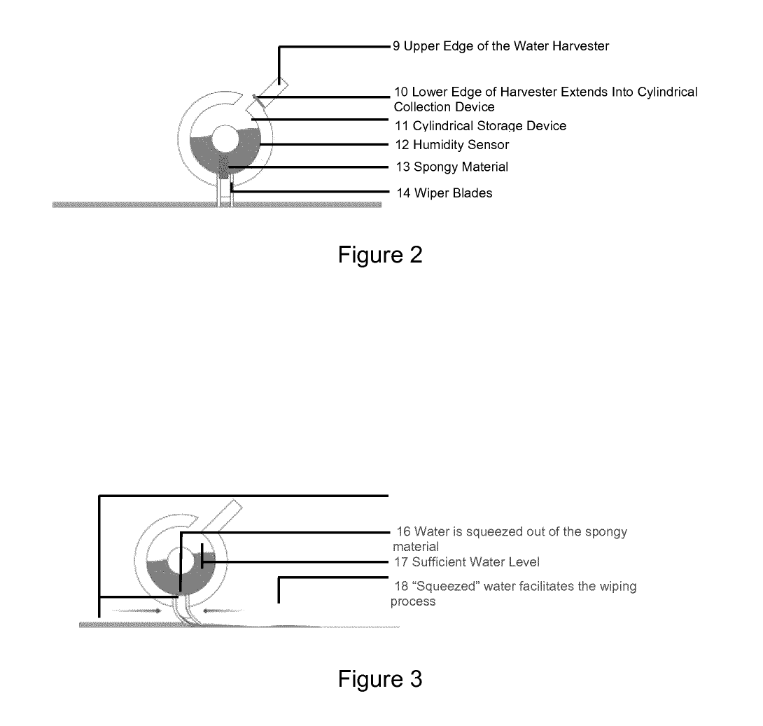

FIG. 2 illustrates one implementation of an integrated collection and wiper system 6 in detail. The lower edge of the harvester 10 extends into the cylindrical collection device, where it will be stored and used to clean the surface when sufficient quantities of water have been collected. The wiper system 6 comprises, in one implementation, a medium 13 to transport water to the surface sandwiched between outer wiper blades 14 on each side. In various implementations, the medium 13 can be an absorbent material or a “duck valve” or a soft, polymeric plug attached to the end of the wiper blade. The outer wiper blades 14 are preferably constructed of flexible, light and durable materials (e.g. rubber, elastic materials such as Ethylene Propylene Diene Monomer (EPDM) are ideal as they are low cost and have excellent wear and corrosion properties).

In one implementation, the outer wiper blades 14 are configured to engage the surface that is to be wiped/cleaned, such as the outer optics of a solar panel or the window panel of a high-rise. In one implementation, as shown in FIGS. 2 and 3, the outer wiper blades 14 extend beyond the absorbent material 13, such that only the wiper blades 14 contact the surface. These outer blades 14 serve the purpose of wiping the heavy dirt accumulation from the surfaces that need cleaning (e.g. Solar panels, glass windows) and protect the absorbent material 13 from dirt and wear.

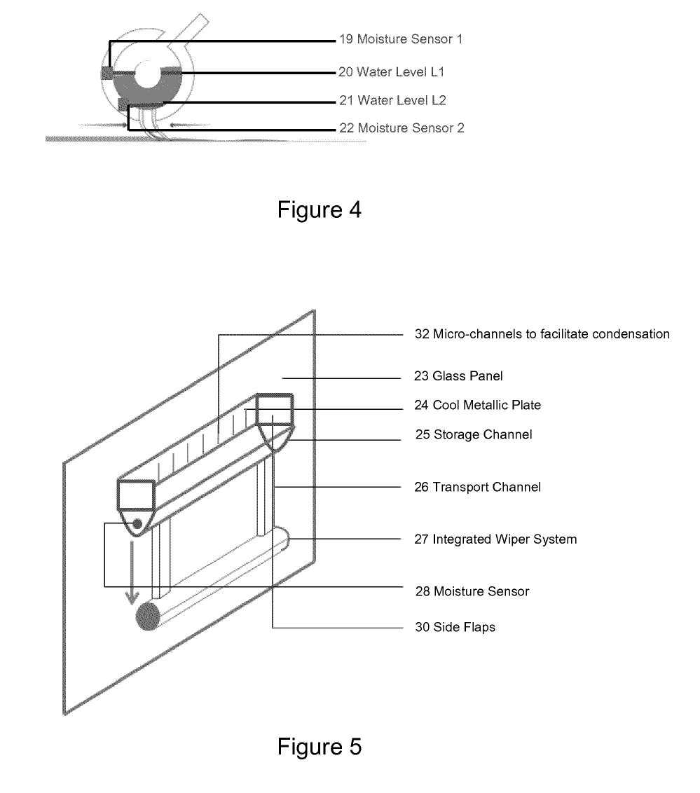

FIG. 3 illustrates integrated collection and wiper system in dynamic motion. The adsorbent material 13 protrudes from the inside of the cylinder 11 and enables the water to be squeezed out during wiping phases. The pressure generated from friction during motion deforms the blades 15 so that the water is squeezed out of the spongy material 16 to facilitate the wiping process. A moisture sensor 19 is integrated inside the cylindrical collection device to trigger the wiper blades when the sufficient water level L1 20 is reached. A second moisture sensor 22 is used to halt the wiper movement when the water level goes below water level two 21 and the wiper component returns to its initial position to resume water collection. These characteristics are illustrated in FIG. 4.

Although one implementation of the invention relates to cleaning solar panels and the like, another implementation relates to cleaning other types of panels. Another aspect of the invention described above provides a cleaning mechanism that can be used with or integrated into the glass panels and is part of the building architecture and which is able to automatically clean the glass surfaces on a regular basis.

For applications relating to building panels, the cooling and water condensation process is enhanced. Office buildings in cities of subtropical and tropical climates are continuously cooled and there is a significant temperature difference between the air inside and outside the buildings. These temperature differences could be as high as 10-25° C. In one implementation, a conductive metal plate 24 with width ranging from 1-10 cm and height ranging from 1-10 cm and with length chosen as required by the user is positioned above the glass panels that need to be cleaned regularly 23. One side of the plate is exposed to the cooler air inside the building and the opposite side of the plate is exposed to the outside. This temperature differential between the plate 24 and the air encourages condensation (dependent on humidity and the relative temperatures). In one implementation, the exposed surface of the plate 24 to the outer atmosphere contains two side flaps 30 (see FIG. 5) at either end to prevent moisture evaporation from high winds. The exposed surface of the plate 24 also has vertical micro channels 32 (see FIG. 5) to facilitate efficient flow of condensed water to the storage channel 25. This water condenses into a storage channel 25. A cleaning system as described, such as the implementation shown in FIG. 1 is then placed in communication with, in one implementation mounted to, the storage channels 25 via transport channels 26 as shown in FIG. 5.

In operation, water will condense on the plate 24. The water will collect and flow into the storage channel 25. The collected water is then transported, such as via channels 26, to the collection device 6.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed:

1. A fluid harvesting device comprising:
a harvester comprising a hydrophobic surface;
a collection device adjacent the harvester and configured to receive liquid from the surface of the harvester.

2. The device of claim 1, wherein the harvester includes a plurality of channels extending to the collection device and wherein the collection device has a plurality of openings corresponding to the plurality of channels.

3. The collection device of claim 1, wherein the collection device includes an outlet.

4. The collection device of claim 3, wherein the outlet is positioned adjacent to a wiper blade and configured to provide fluid from the collection device to the wiper blade.

5. A cleaning device comprising:
a harvester positioned on a collection device, the harvester having a surface for condensing water from air;
the collection device including an inlet in fluid communication with the surface of the harvester, the collection device further including an outlet;
a wiper assembly comprising a first outer wiper blade and a second outer wiper blade with a fluid directing material disposed there between, the fluid directing material in fluid communication with the outlet of the collection device.

6. The cleaning device of claim 5, wherein the fluid directing material is elastically compressible.

7. The cleaning device of claim 6, wherein the first outer wiper blade and second outer wiper blade are movable relative to each other and the fluid directing materials disposed there between is compressed upon movement of the first outer wiper blade towards the second outer wiper blade.

8. The cleaning device of claim 5, further comprising a wiping mechanism in communication with at least one of the first outer wiper blade and second outer wiper blade and configured to impart movement.

9. The cleaning device of claim 5, wherein the wiping mechanism comprises a motor and gear system.

10. The cleaning device of claim 5, wherein the harvester, collection device, and wiper assembly are in communication with a wiping mechanism for movement relative to a surface to be wiped by the wiper assembly.

11. The cleaning device of claim 5 wherein the harvester comprises a plate having an inner surface and an outer surface and a high thermal conductivity.

12. The cleaning device of claim 5, wherein the harvester surface comprises a hydrophobic material and includes a plurality of channels in communication with the inlet of the collection device.

13. A method of collecting liquid and cleaning a surface comprising:
condensing liquid on a harvester's surface;
channeling the condensed liquid into a collection device;
dispensing liquid from the collection device to a wiper assembly;
moving a wiper of the wiper assembly across a portion of the surface spreading water on the surface as the wiper is moved.

14. The method of claim 13, wherein the dispensing of the liquid from the collection device is into a flexible material.

15. The method of claim 14, further comprising compressing the flexible material with the wiper to release water to the surface.
